(19) United States
(12) Patent Application Publication
(10) Pub. No.: US 2016/0248963 A1
(43) Pub. Date: Aug. 25, 2016

(54) Terminal photographing/camera shooting processing method, device and system

(71) Applicant: ZTE CORPORATION, Guangdong (CN)

(72) Inventor: Yushen ZHOU, Shenzhen, Guangdong Province (CN)

(73) Assignee: ZTE CORPORATION, Shenzhen, Guangdong Province (CN)

(21) Appl. No.: 14/916,849

(22) PCT Filed: Nov. 11, 2013
(86) PCT No.: PCT/CN2013/086874

§ 371 Date: Apr. 12, 2016

(30) Foreign Application Priority Data
Sep. 10, 2013 (CN) 201310408481.5

(51) Int. Cl. H04N 5/232; H04B 1/3827

(52) U.S. Cl. CPC H04N 5/23206; H04B 1/3833; H04N 5/23241

(57) ABSTRACT

Provided are a method, device and system for processing terminal photographing and/or camera shooting. The method comprises that: a separate device which is separated from a terminal body and used for photographing and/or camera shooting, receives instruction information from the terminal body, wherein the instruction information is used for instructing to perform photographing and/or camera shooting; the separate device collects photographing and/or camera shooting data according to the instruction information; and the separate device sends the collected photographing and/or camera shooting data to the terminal body, wherein the terminal body displays a photographing and/or camera shooting picture according to the photographing and/or camera shooting data. By means of the present disclosure, effects that the photographing and/or camera shooting are/is not limited by a position or an angle and the user experience is improved are achieved.

### TECHNICAL FIELD

The present disclosure relates to the field of communications, and in particular to a method, device and system for processing terminal photographing and/or camera shooting.

### BACKGROUND

Currently, photographing and/or camera shooting components are integrated on all mobile terminals and provide photographing and/or camera shooting service for the mobile terminals. This function of photographing and/or camera shooting has become a necessary function of each mobile terminal. However, the photographing and/or camera shooting components on the current mobile terminals are fixed, and photographing and/or camera shooting functions are completed by placing the mobile terminals to different positions. Due to the own limitations of the mobile terminals, photographing and/or camera shooting areas or angles are limited, and high user experience cannot be realized.

Thus, the problem of low user experience caused by the limitation of photographing and/or camera shooting due to the fact that the photographing and/or camera shooting component is integrated on the mobile terminal exists in the related art.

### SUMMARY

A method and system for processing terminal photographing and/or camera shooting processing are provided in the embodiment of the present disclosure, which are intended to at least solve the problem of low user experience caused by the limitation of photographing and/or camera shooting due to the fact that a photographing and/or camera shooting component is integrated on the mobile terminal in the related art.

According to one aspect of the present disclosure, a method for processing terminal photographing and/or camera shooting is provided, comprising: receiving, by a separate device which is separated from a terminal body and used for photographing and/or camera shooting, instruction information from the terminal body, wherein the instruction information is used for instructing to perform photographing and/or camera shooting; collecting, by the separate device, photographing and/or camera shooting data according to the instruction information; and sending, by the separate device, the collected photographing and/or camera shooting data to the terminal body.

According to an exemplary embodiment, when the separate device is connected to the terminal body via a physical interface, the separate device receives the instruction information from the terminal body via the physical interface and transmits the photographing and/or camera shooting data to the terminal body via the physical interface; and/or, when the separate device is separated from the terminal body, the separate device receives the instruction information from the terminal body via a wireless communication link and transmits the photographing and/or camera shooting data to the terminal body via the wireless communication link.

According to an exemplary embodiment, when the separate device is separated from the terminal body, the method further comprises: detecting, by the separate device, that the separate device is connected to the terminal body via the physical interface; closing, by the separate device, the wireless communication link between the separate device and the terminal body, and performing, by the separate device, communication with the terminal body via the physical interface; and stopping supplying power to the separate device by a rechargeable power supply in the separate device, and charging the rechargeable power supply via the physical interface.

According to the other aspect of the present disclosure, a method for processing terminal photographing and/or camera shooting is provided, comprising: sending instruction information to a separate device which is separated from a terminal body and used for photographing and/or camera shooting, wherein the instruction information is used for instructing to perform photographing and/or camera shooting; and receiving photographing and/or camera shooting data sent from the separate device, wherein the photographing and/or camera shooting data are collected by the separate device according to the instruction information.

According to an exemplary embodiment, the terminal body is connected to the separate device via a physical interface, the physical interface is embedded into a card slot, and the card slot is configured to fix the separate device to the terminal body.

According to an exemplary embodiment, further comprising: charging, by the terminal body, a rechargeable power supply of the separate device via the physical interface, wherein the rechargeable power supply supplies power to the separate device when the separate device is separated from the terminal body.

According to another aspect of the present disclosure, a device for processing terminal photographing and/or camera shooting is provided, wherein the device is located in a separate device which is separated from a terminal body and used for photographing and/or camera shooting, and the device comprises: a first receiving component, configured to receive instruction information from the terminal body, wherein the instruction information is used for instructing to perform photographing and/or camera shooting; a collecting component, configured to collect photographing and/or camera shooting data according to the instruction information; and a first sending component, configured to send the collected photographing and/or camera shooting data to the terminal body.

According to an exemplary embodiment, the first receiving component is further configured to receive, when the separate device is connected to the terminal body via a physical interface, the instruction information from the terminal body via the physical interface, and the first sending component is further configured to transmit the photographing and/or camera shooting data to the terminal body via the physical interface; and/or, the first receiving component is further configured to receive, when the separate device is separated from the terminal body, the instruction information from the terminal body via a wireless communication link, and the first sending component is further configured to transmit the photographing and/or camera shooting data to the terminal body via the wireless communication link.

According to an exemplary embodiment, further comprising: a detecting component, configured to detect, when the separate device is separated from the terminal body, that the separate device is connected to the terminal body via the physical interface; a controlling component, configured to close the wireless communication link between the separate device and the terminal body, wherein the separate device performs communication with the terminal body via the physical interface; and the controlling component, further configured to control a rechargeable power supply in the separate device to stop supplying power to the separate device, and charge the rechargeable power supply via the physical interface.

According to another aspect of the present disclosure, a device for processing terminal photographing and/or camera shooting is provided, comprising: a second sending component, configured to send instruction information to a separate device which is separated from a terminal body and used for photographing and/or camera shooting, wherein the instruction information is used for instructing to perform photographing and/or camera shooting; and a second receiving component, configured to receive photographing and/or camera shooting data sent from the separate device, wherein the photographing and/or camera shooting data are collected by the separate device according to the instruction information.

According to an exemplary embodiment, a physical interface configured to connect the separate device to the terminal body is embedded into a card slot, and the card slot is configured to fix the separate device to the terminal body.

According to an exemplary embodiment, the physical interface is further configured for the terminal body to charge a rechargeable power supply of the separate device, and the rechargeable power supply supplies power to the separate device when the separate device is separated from the terminal body.

According to another aspect of the present disclosure, a system for processing terminal photographing and/or camera shooting is provided, comprising the above two devices for processing terminal photographing and/or camera shooting.

By means of the present disclosure, the separate device which is separated from a terminal body and used for photographing and/or camera shooting, receives the instruction information from the terminal body, wherein the instruction information is used for instructing to perform photographing and/or camera shooting; the separate device collects the photographing and/or camera shooting data according to the instruction information; and the separate device sends the collected photographing and/or camera shooting data to the terminal body, wherein the terminal body displays the photographing and/or camera shooting picture according to the photographing and/or camera shooting data. The problem of low user experience caused by the limitation of photographing and/or camera shooting due to the fact that the photographing and/or camera shooting component is integrated on the mobile terminal in the related art is solved, thereby achieving effects that the photographing and/or camera shooting are/is not limited by a position or an angle and the user experience is improved.

### BRIEF DESCRIPTION OF THE DRAWINGS

The drawings described here are intended to provide further understanding of the present disclosure, and form a part of the present disclosure. The schematic embodiments and descriptions of the present disclosure are intended to explain the present disclosure, and do not form improper limits to the present disclosure. In the drawings:

FIG. 1 is a flowchart of a first method for processing terminal photographing and/or camera shooting according to an embodiment of the present disclosure;

FIG. 2 is a flowchart of a second method for processing terminal photographing and/or camera shooting according to an embodiment of the present disclosure;

FIG. 3 is a structure block diagram of a first device for processing terminal photographing and/or camera shooting according to an embodiment of the present disclosure;

FIG. 4 is an examplary structure block diagram of the first device for processing terminal photographing and/or camera shooting according to an embodiment of the present disclosure;

FIG. 5 is a structure block diagram of a second device for processing terminal photographing and/or camera shooting according to an embodiment of the present disclosure;

FIG. 6 is a structure block diagram of a system for processing terminal photographing and/or camera shooting according to an embodiment of the present disclosure;

FIG. 7 is a structural diagram of a system for processing photographing and/or camera shooting according to an examplary implementation mode of the present disclosure; and

FIG. 8 is a communication mode diagram of separation of a separate device D from a host A according to an examplary implementation mode of the present disclosure.

### DETAILED DESCRIPTION OF THE EMBODIMENTS

The present disclosure is described below with reference to the drawings and the embodiments in detail. It is important to note that the embodiments of the present disclosure and the characteristics in the embodiments can be combined under the condition of no conflicts.

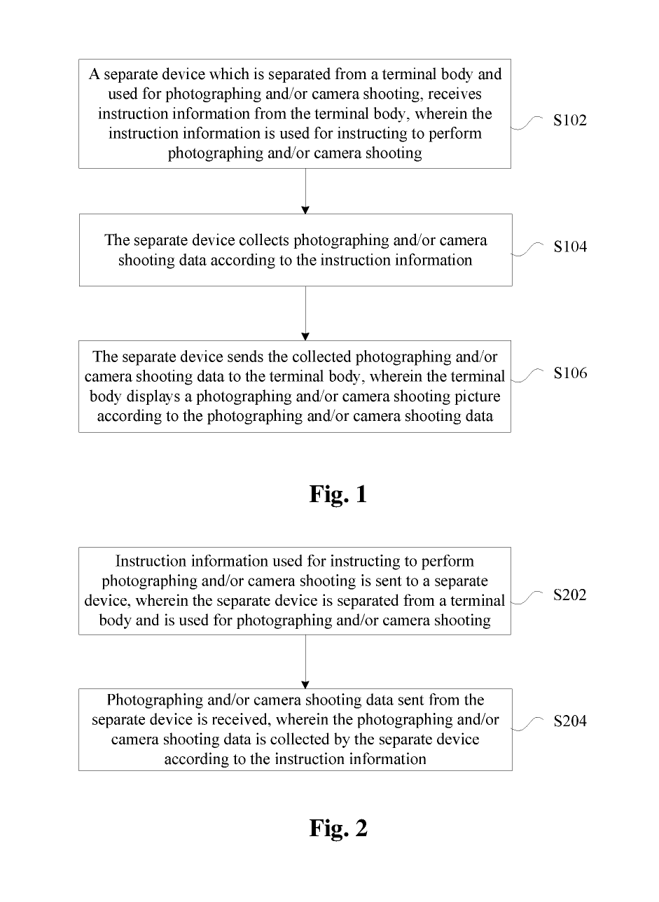

In the present embodiment, a method for processing terminal photographing and/or camera shooting is provided. FIG. 1 is a flowchart of the first method for processing terminal photographing and/or camera shooting according to an embodiment of the present disclosure. As shown in FIG. 1, the flow comprises the steps as follows.

Step S102: A separate device which is separated from a terminal body and used for photographing and/or camera shooting, receives instruction information from the terminal body, wherein the instruction information is used for instructing to perform photographing and/or camera shooting.

Step S104: The separate device collects photographing and/or camera shooting data according to the instruction information.

Step S106: The separate device sends the collected photographing and/or camera shooting data to the terminal body, wherein the terminal body displays a photographing and/or camera shooting picture according to the photographing and/or camera shooting data.

By means of the steps, the separate device which is separated from the terminal body and used for photographing and/or camera shooting, so that the separate device can be placed at any position and is not affected by a position where a terminal is located. Compared with the related art that the photographing and/or camera shooting component is integrated on the mobile terminal, the problem of low user experience caused by the limitation of photographing and/or camera shooting due to the fact that the photographing and/or camera shooting component is integrated on the mobile terminal in the related art is solved, thereby achieving the effects that the photographing and/or camera shooting are/is not limited by the position or the angle and the user experience is improved.

Under the condition that the separate device is connected to the terminal body via the physical interface, the separate device receives the instruction information from the terminal body via the physical interface, and transmits the photographing and/or camera shooting data to the terminal body via the physical interface; and/or, under the condition that the separate device is separated from the terminal body, the separate device receives the instruction information from the terminal body via a wireless communication link, and transmits the photographing and/or camera shooting data to the terminal body via the wireless communication link.

Under the condition that the separate device is connected to the terminal body via the physical interface, the physical interface is embedded into a card slot configured to fix the separate device to the terminal body. The physical interface may be further configured for the terminal body to charge a rechargeable power supply of the separate device, wherein the rechargeable power supply supplies power to the separate device when the separate device is separated from the terminal body.

In an exemplary embodiment, under the condition that the separate device is separated from the terminal body, the method further comprises that: it is detected that the separate device is connected to the terminal body via the physical interface; the separate device closes the wireless communication link between the separate device and the terminal body, and the separate device performs communication with the terminal body via the physical interface; and the rechargeable power supply in the separate device stops supplying power to the separate device, and is charged via the physical interface. The mutual conversion of different connection modes between the separate device and the terminal body is realized, and the selectivity of a user is improved.

In the embodiment, a method for processing terminal photographing and/or camera shooting is also provided. FIG. 2 is a flowchart of the second device for processing terminal photographing and/or camera shooting according to an embodiment of the present disclosure. As shown in FIG. 2, the flow comprises the steps as follows.

Step S202: Instruction information used for instructing to perform photographing and/or camera shooting is sent to a separate device, wherein the separate device is separated from a terminal body and used for photographing and/or camera shooting.

Step S204: Photographing and/or camera shooting data sent from the separate device is received, wherein the photographing and/or camera shooting data is collected by the separate device according to the instruction information.

In an exemplary embodiment, the terminal body is connected to the separate device via a physical interface, and the physical interface is embedded into a card slot, wherein the card slot is configured to fix the separate device to the terminal body.

A rechargeable power supply of the separate device can further be charged by the terminal body via the physical interface. The rechargeable power supply supplies power to the separate device when the separate device is separated from the terminal body.

In the embodiment, a device for processing terminal photographing and/or camera shooting is further provided. The device is configured to realize the embodiments and the examplary implementation modes, and the described embodiments and examplary implementation modes are no longer described in detail. Just as a term ‘component’ used below, the combination of software and/or hardware with predetermined functions can be realized. Although the system described by the following embodiment is better realized by the software, the realization of the hardware or the combination of the software and the hardware may be possible and may be constructed.

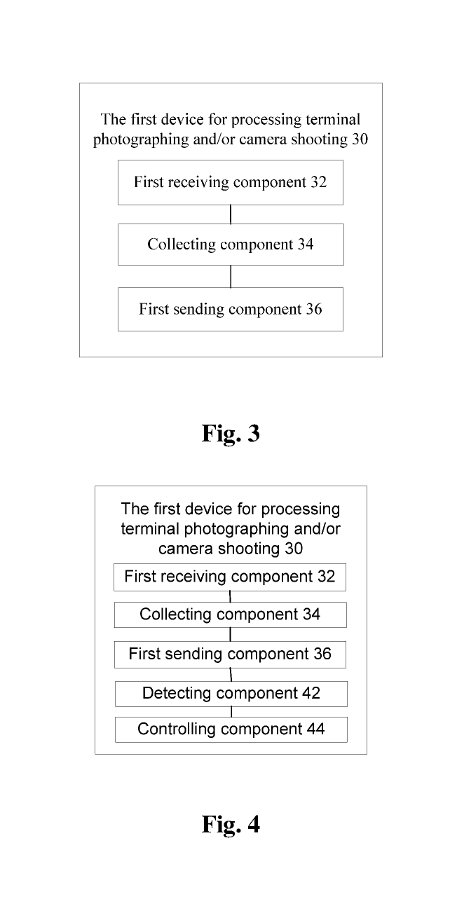

FIG. 3 is a structure block diagram of a first device for processing terminal photographing and/or camera shooting according to an embodiment of the present disclosure. As shown in FIG. 3, the first device for processing terminal photographing and/or camera shooting 30 is located in a separate device which is separated from a terminal body and used for photographing and/or camera shooting, and comprises: a first receiving component 32, a collecting component 34 and a first sending component 36. The device is described below.

The first receiving component 32 is configured to receive instruction information from the terminal body, wherein the instruction information is used for instructing to perform photographing and/or camera shooting; the collecting component 34 is connected to the first receiving component 32 and is configured to collect photographing and/or camera shooting data according to the instruction information; and the first sending component 36 is connected to the collecting component 34 and is configured to send the collected photographing and/or camera shooting data to the terminal body.

In an exemplary embodiment, the first receiving component 32 is further configured to receive, under the condition that the separate device is connected to the terminal body via a physical interface, the instruction information from the terminal body via the physical interface, and the first sending component is further configured to transmit the photographing and/or camera shooting data to the terminal body via the physical interface; and/or, the first receiving component is further configured to receive, under the condition that the separate device is separated from the terminal body, the instruction information from the terminal body via a wireless communication link, and the first sending component is further configured to transmit the photographing and/or camera shooting data to the terminal body via the wireless communication link.

FIG. 4 is an examplary structure block diagram of the first device for processing terminal photographing and/or camera shooting according to an embodiment of the present disclosure. As shown in FIG. 4, the device further comprises a detecting component 42 and a controlling component 44 in addition to all the structures shown in FIG. 3. The examplary structure is described below.

The detecting component 42 is connected to the first sending component 36 and is configured to detect, under the condition that the separate device is separated from the terminal body, that the separate device is connected to the terminal body via the physical interface; the controlling component 44 is connected to the detecting component 42 and is configured to close the wireless communication link between the separate device and the terminal body, wherein the separate device performs communication with the terminal body via the physical interface; and the controlling component 44 is further configured to control a rechargeable power supply in the separate device to stop supplying power to the separate device, and charge the rechargeable power supply via the physical interface.

FIG. 5 is a structure block diagram of the second device for processing terminal photographing and/or camera shooting according to an embodiment of the present disclosure. As shown in FIG. 5, the second terminal photographing and/or camera shooting processing device 50 comprises: a second sending component 52 and a second receiving component 54. The device is described below.

The second sending component 52 is configured to send instruction information used for instructing to perform photographing and/or camera shooting to a separate device, wherein the separate device is which is separated from a terminal body and used for photographing and/or camera shooting; and the second receiving component 54 is connected to the second sending component 52 and is configured to receive photographing and/or camera shooting data sent from the separate device, wherein the photographing and/or camera shooting data is collected by the separate device according to the instruction information.

The second device for processing terminal photographing and/or camera shooting can further comprise a physical interface configured to connect the separate device to the terminal body, the physical interface is embedded into a card slot, and the card slot is configured to fix the separate device to the terminal body.

In an exemplary embodiment, the physical interface is further configured for the terminal body to charge a rechargeable power supply of the separate device, wherein the rechargeable power supply supplies power to the separate device when the separate device is separated from the terminal body.

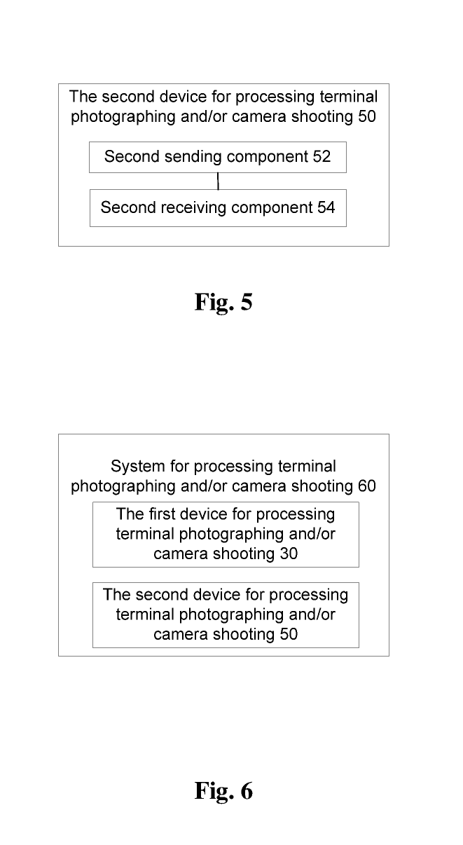

In the embodiment, a system for processing terminal photographing and/or camera shooting is further provided. FIG. 6 is a structure block diagram of a system for processing terminal photographing and/or camera shooting according to an embodiment of the present disclosure. As shown in FIG. 6, the system 60 comprises the first device for processing terminal photographing and/or camera shooting 30 according to any one of content mentioned above and the second device for processing terminal photographing and/or camera shooting 50 according to any one of the content mentioned above.

As for the problem in the related art that the user experience cannot be met due to the fact that the mobile terminal and the photographing and/or camera shooting component are fixed together and therefore a photographing and/or camera shooting area or angle is limited, in the embodiment, a method and system for mobile terminal photographing and/or camera shooting separately is provided. In the solution, the photographing and/or camera shooting component are separated from the mobile terminal, so that the photographing and/or camera shooting component may not have to be fixed to the mobile terminal, and may move around instead; and by means of communication between the photographing and/or camera shooting component and the mobile terminal, a photographing and/or camera shooting function is completed, a photographing and/or camera shooting range is better expanded, and the user experience is effectively improved.

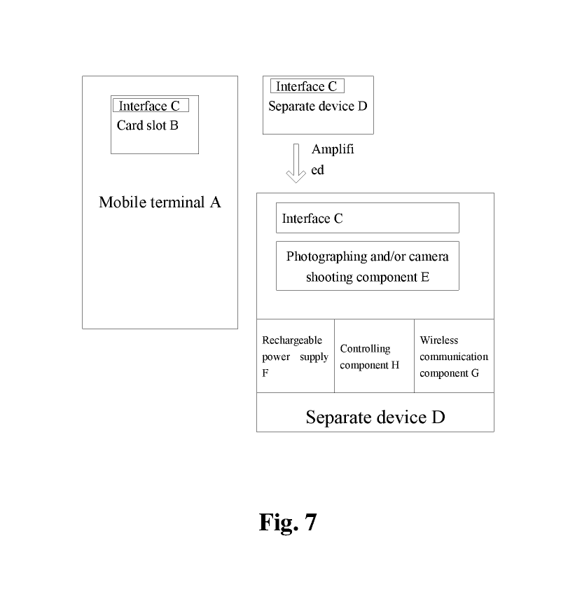

FIG. 7 is a structural diagram of a system for processing photographing and/or camera shooting according to an examplary implementation mode of the present disclosure. As shown in FIG. 7, the photographing and/or camera shooting component and the mobile terminal in the structure are separable, namely the photographing and/or camera shooting component therein is a separable photographing and/or camera shooting component. As shown in FIG. 1, the system comprises two parts: one part: a mobile terminal A (or named a host A, which is equivalent to an above-mentioned end body), a card slot B in the mobile terminal A and an interface C1 on the card slot B; and the other part: a separate device D (which is equivalent to the above-mentioned separate device in function), and an interface C2, corresponding to the interface C1, on the separate device D, wherein the separate device D comprises at least one of: a photographing and/or camera shooting component E, a rechargeable power supply F, a controlling component H and a wireless communication component G. The two parts are described below respectively.

The mobile terminal A (which is uniformly referred to as the host A below). The host A provides a screen for a user to watch a picture and effect of the photographing and/or camera shooting component E, provides the screen for the user to operate and preview photographing and/or camera shooting, and supplies power to the photographing and/or camera shooting component E, and communicates with the photographing and/or camera shooting component E.

The card slot B (as the above-mentioned card slot): the card slot B in the host A is configured to fix the photographing and/or camera shooting component E, and can be removed manually by a user.

Interface C1 (as the above-mentioned physical interface): a group of Interfaces C1 in the card slot B at least provide the following functions: power supplying and charging service is provided for the photographing and/or camera shooting component E by using a battery of the host A via the interface C1; and the host A performs data communication and command communication with the photographing and/or camera shooting component E via the interface C1, so that the photographing and/or camera shooting component E transmits collected image data to the host A. The interface C1 can be a USB (Universal Serial Bus) interface, or can be one of other self-defined interfaces.

The separate device D: the separate device D comprises at least one of: the photographing and/or camera shooting component E, the rechargeable power supply F, the controlling component H and the wireless communication component G, and a component which is formed by integrating together a group of the above equipment. The separate device D can communicate with the host A via an interface C2, can be fixed to the host A via the card slot B without falling, and can be automatically stripped by the user. Meanwhile, the separate device D can be provided a similar adhesion device capable of adhering to glass, and all devices included by the separate device D is described below.

The photographing and/or camera shooting component E: the photographing and/or camera shooting component E is a main component on the separate device D, and completes a photographing and/or camera shooting function.

The rechargeable power supply F: When the separate device D is separated from the host A, the rechargeable power supply F supplies needed power to the functions of the separate device D. When the separate device D is connected to the host A, the rechargeable power supply F is charged from the host A in case of low electric quantity.

The wireless communication component G: the wireless communication component G can be a Wireless Fidelity (wifi) component or can be a Bluetooth component. The wifi component is emphatically discussed here. The wifi component is configured to perform wifi communication with the host, transmit data to the host A and receive a control instruction from the host A.

The controlling component H (equivalent to the detecting component 42 and the controlling component 44 in function): the controlling component can be a software component. The user receives an instruction instructing whether to take a photograph from the host A via the wireless communication component G, and transmits data obtained by photographing to the host A via the wireless communication component G. It is important to note that when the separate device D and the host A are connected together, the controlling component H receives the instruction and transmits the data via the interface C; and when the separate device D and the host A are separated, the controlling component H receives the instruction and transmits the data via the wireless communication component G. The controlling component H mainly controls the photographing and/or camera shooting component E.

The communication mode of the wireless communication component G: which comprises: the wireless communication component G is connected to the host A in a wifi display mode, the wireless communication component G is connected to the host A in a wifi direct mode, and the wireless communication component G is connected to the host A in a wifi Access Point (AP)-client mode. In the above first mode, the host A only views the data of the photographing and/or camera shooting component E passively without the ability of control. In the other two modes, the host A can control photographing or camera shooting respectively.

The processing of photographing and/or camera shooting is described below according to the two conditions that the separate device D and the host A are connected and separated.

1. When the separate device D and the host A are connected together, the wireless communication component G does not work, the rechargeable power supply does not supply power, and charging operation of the host A via the interface C (a common term of the interface C1 on the host and the interface C2 of the separate device D) is accepted only in case of low electric quantity. When the user performs photographing or camera shooting via the screen of the host A or other keys, a command is transmitted to the controlling component H via the interface C, and the controlling component H controls the photographing and/or camera shooting component E to perform photographing or camera shooting, and transmits original data of an image or a video to the host A via the interface C.

2. When the separate device D and the host A are separated and the interface C is no longer connected, the power supply F will automatically turn into a power supply state. When the controlling component H detects that the interface C is no longer connected, the wireless communication component G is started to search for a wifi signal. Meanwhile, when the host A detects that the interface C is no longer connected, the wifi component is automatically started and set as an AP component, and a Service Set Identifier (SSID) of the wifi component is set as camera-ssid. Meanwhile, the wireless communication component G searches for the SSID (camera-ssid), and a password is automatically input for connection after the SSID is found, wherein the set SSID name and password are both set in advance.

After wifi is connected, the host A and the controlling component H can directly communicate in a prescribed protocol mode. A communication distance depends on a distance of wifi communication of the host A. The effect of performing photographing and/or camera shooting preview on the host A by the user is the same as that before separation. The user can press a photographing key on the same interface, the command is transmitted to the controlling component H via the wifi, the controlling component H controls the photographing and/or camera shooting component E to take a photograph, and then data are collected and transmitted to the host A via the wifi to form a picture.

When the user performs camera shooting on the host A, camera shooting data which is collected in real time are transmitted to the host A via the controlling component H, is displayed on the screen and is stored in a file system.

After being separated from the host, the separate device D can be adhered to the glass, a tile or other devices via an adhesion system.

After the separate device D is separated from the host A, the wifi is connected and an Internet Protocol (IP) is allocated, the host A sends a control command to the controlling component H; after a bilateral negotiation, the controlling component H will compress preview data of the photographing and/or camera shooting component E constantly and then transmit the compressed preview data to the host A, the host A decompresses the compressed preview data and then sends the decompressed data into a display for the user to preview the data on the screen, and the effect is the same as that before separation.

Descriptions are performed below by adopting a micro-USB interface component as the physical interface C and adopting Universal Plug and Play (upnp) for communication therebetween.

When the separate device D is separated from the host A, the physical interfaces C of the separate device D and the physical interfaces C of the host A will be separated in a separation process.

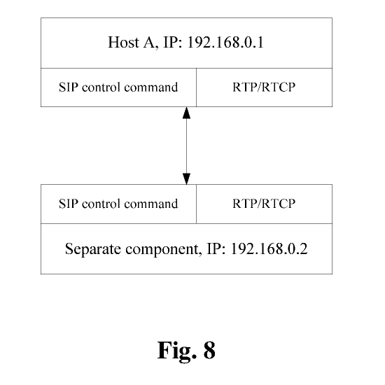

FIG. 8 is a communication mode diagram of separation of a separate device D from a host A according to an examplary implementation mode of the present disclosure. As shown in FIG. 8, after the physical interfaces C are separated, the host A will automatically detect USB disconnection. At this time, the host A will automatically open the wifi component, the wifi component is set from a common client component to the AP component, a fixed password is set, and the SSID is named camera-ssid.

After the physical interfaces C are separated, the rechargeable power supply F start power supplying operation to perform system power supplying on the whole separate device D.

After the physical interfaces C are separated, when the controlling component H detects USB disconnection, the wireless communication component G is started, that is, the wifi is opened, and the set AP (camera-ssid) starts to be searched; after the camera-ssid is found, connection is performed to go into a host AP according to the fixed password, and the host AP allocates an address as 192.168.0.2; and at this time, the own IP address of the host A is 192.168.0.1.

After the host A detects the address 192.168.0.2, a Session Imitation Protocol (SIP) of a control protocol component is started, and the SIP is sent to the controlling component H to negotiate for communication; after the bilateral negotiation succeeds, preview data of a photographing component, collected by the controlling component H, are YUV data firstly; after compressing into H264, the YUV data are transmitted to the host A via a Rapid Transport Protocol (RTP). The host A decodes and recovers the H264 into the YUV data, and the data are sent to the screen to be played. At this time, the user will see separated camera data in real time via the host A.

A photographing instruction is initiated by the operation of the host A. The host A converts the photographing instruction into a message command of the SIP, and sends the message command to the controlling component H. After receiving the message command, the controlling component H starts the photographing and/or camera shooting component E to take a photograph, and after photographing succeeds, 2000K is returned to the host via the SIP; and a jpg format file generated by photographing is sent via the (Real-time Transport Protocol, RTP) to the host to be stored.

A photographing instruction is initiated by the operation of the host A. The host A converts the photographing instruction into an invite command of the SIP, and sends the invite command to the controlling component H. After receiving the invite command, the controlling component H performs negotiation, then video transmission is performed between the negotiated parties via the RTP, and a video stream is stored inside a file at a host end.

When the separation operation is stopped, the separate device D can be put into the card slot B of the host A. When both the host A and the controlling component H detect USB connection, the wifi component is stopped and closed at the same time.

The separation operation is stopped, the charging operation is switched from the rechargeable power supply F to a charging component of the host A and the rechargeable power supply F stops supplying power to the separate device D, and a USB interface supplies power to the separate device D.

The separation operation is stopped, and the SIP and the RTP in the controlling component H stop working. A conventional USB mode is switched, and the host A controls the photographing operation and the camera shooting operation.

Obviously, those skilled in the art should understand that all components or all steps in the present disclosure can be realized by using a generic computation device, can be centralized on a single computation component or can be distributed on a network composed of a plurality of computation components. Optionally, they can be realized by using executable program codes of the computation components, so that they can be stored in a storage component and executed by the computation components, the shown or described steps can be executed in a sequence different from this sequence under certain conditions, or they are manufactured into each integrated circuit component respectively, or a plurality of components or steps therein are manufactured into a single integrated circuit component. Thus, the present disclosure is not limited to combination of any specific hardware and software.

The above is only the preferred embodiments of the present disclosure, and is not intended to limit the present disclosure. There can be various modifications and variations in the present disclosure for those skilled in the art. Any modifications, equivalent replacements, improvements and the like within the spirit and principle of the present disclosure shall fall within the protection scope of the present disclosure.

### INDUSTRIAL APPLICABILITY

As mentioned above, the method, device and system for processing the terminal photographing and/or camera shooting provided by the embodiments of the present disclosure brings the following beneficial effects that: the problem of low user experience caused by the limitation of photographing and/or camera shooting due to the fact that the photographing and/or camera shooting component is integrated on the mobile terminal in the related art is solved, thereby achieving the effects that the photographing and/or camera shooting are/is not limited by the position or the angle and the user experience is improved.

1. A method for processing terminal photographing and/or camera shooting, comprising:
receiving, by a separate device which is separated from a terminal body and used for photographing and/or camera shooting, instruction information from the terminal body, wherein the instruction information is used for instructing to perform photographing and/or camera shooting;
collecting, by the separate device, photographing and/or camera shooting data according to the instruction information; and
sending, by the separate device, the collected photographing and/or camera shooting data to the terminal body.

2. The method as claimed in claim 1, wherein when the separate device is connected to the terminal body via a physical interface, the separate device receives the instruction information from the terminal body via the physical interface and transmits the photographing and/or camera shooting data to the terminal body via the physical interface; and/or,
when the separate device is separated from the terminal body, the separate device receives the instruction information from the terminal body via a wireless communication link and transmits the photographing and/or camera shooting data to the terminal body via the wireless communication link.

3. The method as claimed in claim 2, wherein when the separate device is separated from the terminal body, the method further comprises:
detecting, by the separate device, that the separate device is connected to the terminal body via the physical interface;
closing, by the separate device, the wireless communication link between the separate device and the terminal body, and performing, by the separate device, communication with the terminal body via the physical interface; and
stopping supplying power to the separate device by a rechargeable power supply in the separate device, and charging the rechargeable power supply via the physical interface.

4. A method for processing terminal photographing and/or camera shooting, comprising:
sending instruction information to a separate device which is separated from a terminal body and used for photographing and/or camera shooting, wherein the instruction information is used for instructing to perform photographing and/or camera shooting; and
receiving photographing and/or camera shooting data sent from the separate device, wherein the photographing and/or camera shooting data are collected by the separate device according to the instruction information.

5. The method as claimed in claim 4, wherein the terminal body is connected to the separate device via a physical interface, the physical interface is embedded into a card slot, and the card slot is configured to fix the separate device to the terminal body.

6. The method as claimed in claim 5, further comprising:
charging, by the terminal body, a rechargeable power supply of the separate device via the physical interface, wherein the rechargeable power supply supplies power to the separate device when the separate device is separated from the terminal body.

7. A device for processing terminal photographing and/or camera shooting, wherein the device is located in a separate device which is separated from a terminal body and used for photographing and/or camera shooting, and the device comprises:
a first receiving component, configured to receive instruction information from the terminal body, wherein the instruction information is used for instructing to perform photographing and/or camera shooting;
a collecting component, configured to collect photographing and/or camera shooting data according to the instruction information; and
a first sending component, configured to send the collected photographing and/or camera shooting data to the terminal body.

8. The device as claimed in claim 7, wherein
the first receiving component is further configured to receive, when the separate device is connected to the terminal body via a physical interface, the instruction information from the terminal body via the physical interface, and the first sending component is further configured to transmit the photographing and/or camera shooting data to the terminal body via the physical interface; and/or,
the first receiving component is further configured to receive, when the separate device is separated from the terminal body, the instruction information from the terminal body via a wireless communication link, and the first sending component is further configured to transmit the photographing and/or camera shooting data to the terminal body via the wireless communication link.

9. The device as claimed in claim 8, further comprising:
a detecting component, configured to detect, when the separate device is separated from the terminal body, that the separate device is connected to the terminal body via the physical interface;
a controlling component, configured to close the wireless communication link between the separate device and the terminal body, wherein the separate device performs communication with the terminal body via the physical interface; and
the controlling component, further configured to control a rechargeable power supply in the separate device to stop supplying power to the separate device, and charge the rechargeable power supply via the physical interface.

10. A device for processing terminal photographing and/or camera shooting, comprising:
a second sending component, configured to send instruction information to a separate device which is separated from a terminal body and used for photographing and/or camera shooting, wherein the instruction information is used for instructing to perform photographing and/or camera shooting; and
a second receiving component, configured to receive photographing and/or camera shooting data sent from the separate device, wherein the photographing and/or camera shooting data are collected by the separate device according to the instruction information.

11. The device as claimed in claim 10, wherein a physical interface configured to connect the separate device to the terminal body is embedded into a card slot, and the card slot is configured to fix the separate device to the terminal body.

12. The device as claimed in claim 11, wherein the physical interface is further configured for the terminal body to charge a rechargeable power supply of the separate device, and the rechargeable power supply supplies power to the separate device when the separate device is separated from the terminal body.

13. (canceled)
